(19) United States
(12) Patent Application Publication
(10) Pub. No.: US 2008/0298580 A1
(43) Pub. Date: Dec. 4, 2008

(54) CONTENT DELIVERY SERVER AND CONTENT DELIVERY SYSTEM

(76) Inventors: Hiroshi SUU, Chigasaki-shi (JP); Akira Miura, Sagamihara-shi (JP); Akihiro Kasahara, Sanbu-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/129,764

(22) Filed: May 30, 2008

(30) Foreign Application Priority Data
Jun. 1, 2007 (JP) 2007-147396

(51) Int. Cl. H04L 9/18

(52) U.S. Cl. 380/42

(57) ABSTRACT

A content delivery server comprises a packet generator operative to generate packetized content data; an encryptor operative to encrypt the packetized content data with content key data to generate encrypted content data and also operative to encrypt the content key data with user key data to generate encrypted content key data; a TS multiplexer operative to multiplex the encrypted content data into a transport stream and add the encrypted content key data to a TS header thereof; and a transmitter operative to transmit the transport stream to a user terminal.

### CROSS-REFERENCE TO RELATED APPLICATION

This application is based upon and claims the benefit of priority from the prior Japanese Patent Application No. 2007-147396, filed on Jun. 1, 2007, the entire contents of which are incorporated herein by reference.

### BACKGROUND OF THE INVENTION

1. Field of the Invention

The present invention relates to a content delivery server and content delivery system operative to deliver encrypted content data in response to a request from a user terminal held in a user.

2. Description of the Related Art

A communication terminal connected to the terrestrial television, the AM and FM broadcasting, and additionally communications networks such as the Internet is used to receive data, from which audio and video content data of digital information, for example, can be viewed and listened.

The content data of digital information can be easily copied on the other hand, and accordingly the content data to be delivered is encrypted with a content key as measures. For example, Patent Document 1 (JP 2006-020154A) describes the use of a double key encryption system to encrypt the content data. In the double key encryption system, generally, a server on the transmission side encrypts each content data with content key data to generate encrypted content data. Further, the server encrypts the content key data with user key data, which varies from user to user, to generate encrypted content key data. Then, the server transmits the encrypted content data and the encrypted content key data to a terminal on the reception side. In a word, in the above system, the encrypted content key data sent from the server to the terminal is such data that varies from user to user and from content to content. Therefore, in accordance with the increase in the number of broadcasts in recent digital broadcasting and the increase in the number of subscribers (audiences), the amount of information sent from the server to the terminal increases dramatically. Accordingly, sending the increased content key data may press traffics.

### SUMMARY OF THE INVENTION

In one aspect the present invention provides a content delivery server, comprising: a packet generator operative to generate packetized content data; an encryptor operative to encrypt the packetized content data with content key data to generate encrypted content data and also operative to encrypt the content key data with user key data to generate encrypted content key data; a TS multiplexer operative to multiplex the encrypted content data into a transport stream and add the encrypted content key data to a TS header thereof; and a transmitter operative to transmit the transport stream to a user terminal.

In one aspect the present invention provides a content delivery system, comprising: a user terminal held by a user; and a content delivery server operative, in response to a request for content data from the user terminal, to encrypt the content data with content key data and deliver the encrypted content data, wherein the content delivery server includes a packet generator operative to generate packetized content data, an encryptor operative to encrypt the packetized content data with content key data to produce encrypted content data and also operative to encrypt the content key data with user key data to produce encrypted content key data, a TS multiplexer operative to multiplex the encrypted content data into a transport stream and add the encrypted content key data to a TS header thereof, and a transmitter operative to transmit the transport stream to a user terminal, wherein the user terminal includes a receiver operative to receive the transport stream, a decryptor operative to decrypt the encrypted content data contained in the received transport stream, based on the encrypted content key data added to a TS header of the transport stream, and a reproducer operative to reproduce the decrypted encrypted content data.

### BRIEF DESCRIPTION OF THE DRAWINGS

FIG. 1 is a general diagram of a content delivery system according to a first embodiment of the present invention.

FIG. 2 is a conceptual view showing operation of the content delivery system according to the first embodiment of the present invention.

FIG. 3 is a general diagram of a content delivery system according to a second embodiment of the present invention.

FIG. 4 shows a key management table data 114a for use in the content delivery system according to the second embodiment of the present invention.

FIG. 5 is a conceptual view showing operation of the content delivery system according to the second embodiment of the present invention.

FIG. 6 shows an area of content data to be encrypted in the content delivery system according to the second embodiment of the present invention.

FIG. 7 shows a configuration of 1ch Multi Stream in accordance with the content delivery system according to the second embodiment of the present invention.

FIG. 8 illustrates an example of the encrypted double key scheme applied in MQbic®.

### DETAILED DESCRIPTION OF THE EMBODIMENTS

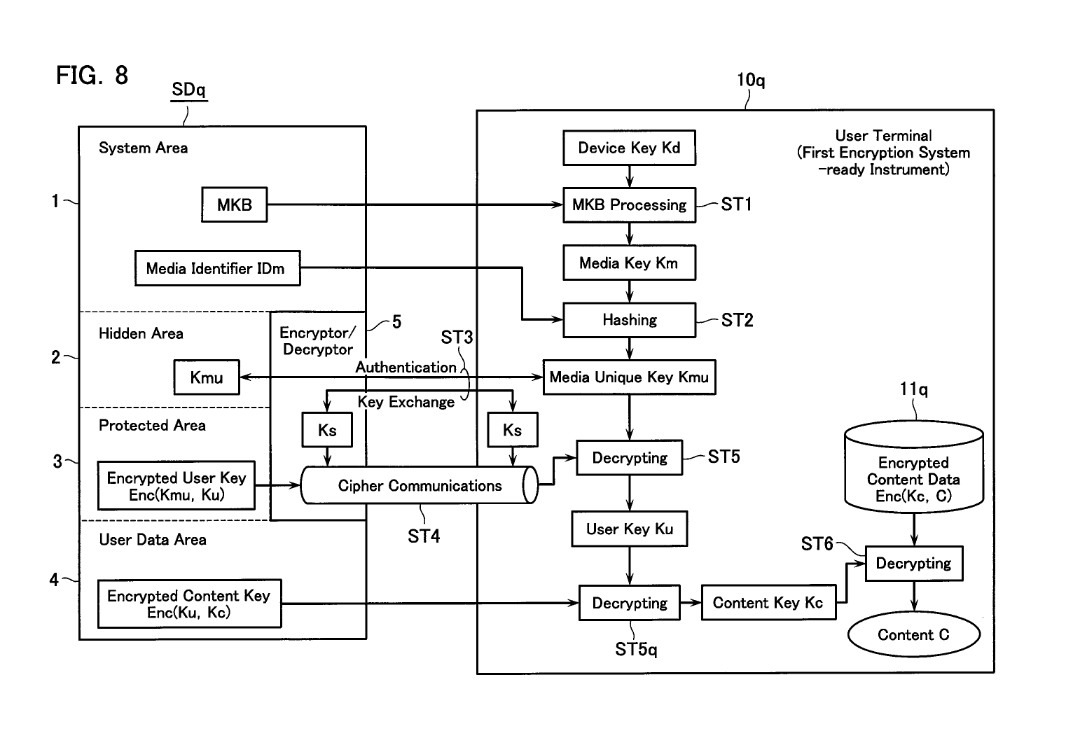

Referring to FIG. 8, an example of the encrypted double key scheme applied in MQbic® is described first. FIG. 8 is a schematic diagram showing a configuration of an SD card and a user terminal corresponding to the encrypted double key scheme applied in MQbic®. The SD card SDq is an example of a secure storage medium that stores data securely, which includes a system area 1, a hidden area 2, a protected area 3, a user data area 4, and an encryptor/decryptor 5. The areas 1-4 are used to store data.

Specifically, such the SD card SDq stores key management information MKB (Media Key Block) and a media identifier IDm in the system area 1, a media unique key Kmu in the hidden area 2, an encrypted user key Enc(Kmu:Ku) in the protected area 3, and an encrypted content key Enc(Ku:Kc) in the user data area 4. The representation of Enc(A:B) means data B encrypted with data A in the present specification. The user key Ku is an encryption/decryption key to the content key Kc and can be used for plural encrypted content keys Enc(Ku:Kc1), Enc(Ku:Kc2), . . . in common. The subscript of q in the SD card SDq represents that the card is ready for MQbic®.

The system area 1 is a read-only area, which is accessible from outside the SD card. The hidden area 2 is a read-only area, which is referenced by the SD card itself and absolutely inaccessible from outside. The protected area 3 is an area, which is readable/writable from outside the SD card with a success of authentication. The user data area 4 is an area, which is freely readable/writable from outside the SD card. The encryptor/decryptor 5 executes authentication, key exchange and cipher communications between the protected area 3 and the outside of the SD card, and has an encryption/decryption function.

For such the SD card SDq, the user terminal 10q for reproduction operates logically as follows. Namely, the user terminal 10q uses a pre-determined device key Kd to perform an MKB-process for the key management information MKB read out of the system area 1 in the SD card SDq (ST1), thereby obtaining a media key Km. Next, the user terminal 10q hashes the media key Km and a media identifier IDm read out of the system area 1 in the SD card SDq (ST2), thereby obtaining a media unique key Kmu.

Thereafter, based on the media unique key Kmu, the user terminal 10q executes authentication and key exchange (AKE: Authentication Key Exchange) with the decryptor 5 in the SD card SDq (ST3), thereby sharing a session key Ks with the SD card SDq. The authentication and key exchange in step S3 is successful if the media unique key Kmu in the hidden area 2 referenced by the decryptor 5 matches with the media unique key Kmu generated in the user terminal 10a. In this case, the session key Ks is shared.

Subsequently, the user terminal 10q reads the encrypted user key Enc(Kmu:Ku) from the protected area 3 via cipher communications using the session key Ks (ST4), and then decrypts the encrypted user key Enc(Kmu:Ku) with the media unique key Kmu (ST5), thereby obtaining the user key Ku.

Finally, the user terminal 20q reads the encrypted content key Enc(Ku:Kc) from the user data area 4 in the SD card SDq, and then decrypts the encrypted content key Enc(Ku:Kc) with the user key Ku (S5q), thereby obtaining the content key Kc. Finally, the user terminal 10a reads the encrypted content Enc(Kc:C) from a memory 11q, and then decrypts the encrypted content Enc(Kc:C) with the content key Kc (ST6), thereby reproducing the obtained content C. In the above example, the encrypted content data is stored in the memory 11q of the user terminal 20q, though it may be stored in an external storage medium.

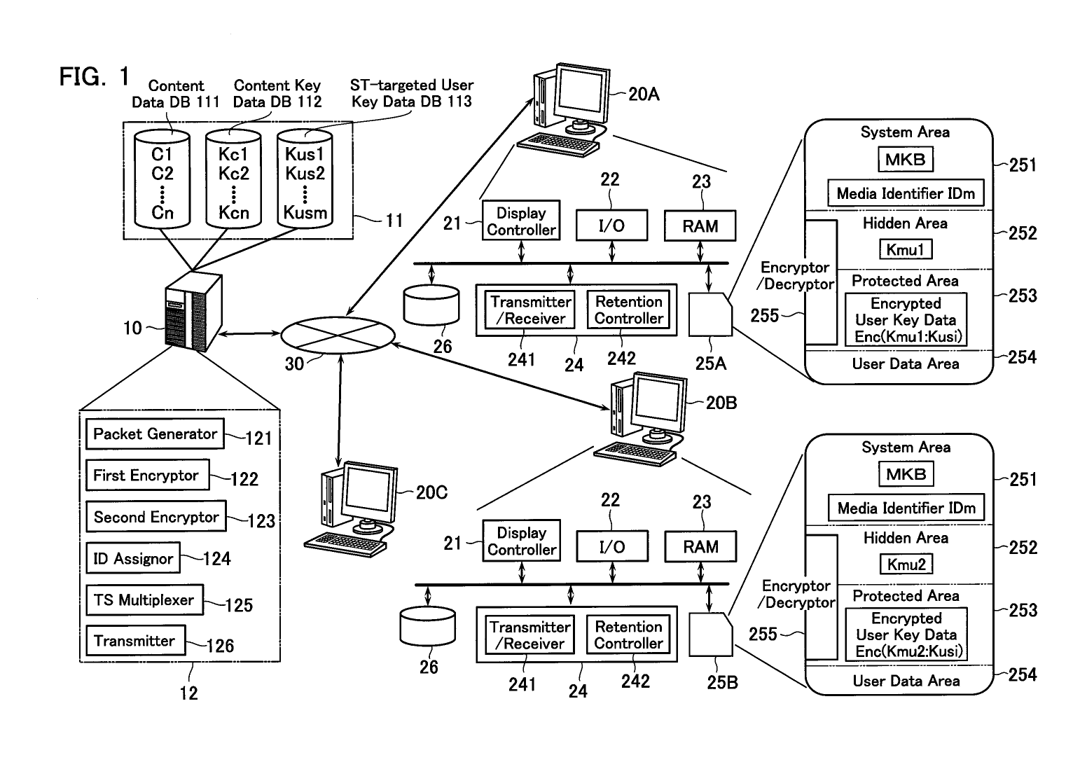

Referring to FIGS. 1-7, an embodiment associated with the content delivery system according to the present invention is described next. The content delivery system according to the present embodiment uses the above encrypted double key scheme or MQbic®. The encrypted double key scheme in the present system employs encrypted content data Enc(Kc:C), which is obtained by encrypting content data C based on content key data Kc.

### First Embodiment

### Configuration of First Embodiment

Referring to FIG. 1, a configuration of a content delivery system according to a first embodiment of the present invention is described. As shown in FIG. 1, the content delivery system according to the first embodiment, mainly, comprises a content delivery server 10 configured to deliver content data, and user terminals 20A, 20B, 20C managed by users. These content delivery server 10 and user terminals 20A, 20B, 20C are connected over a communications network 30 such as the Internet.

FIG. 1 shows an arrangement of one content delivery server 10 and three user terminals 20A, 20B, 20C, though the present invention is not limited to this arrangement. For example, plural such content delivery servers 10 may be arranged and a much more number of the user terminals 20A, 20B, 20C may be provided. The user terminals 20A, 20B, 20C may include cell phones other than PCs, which may be terminals not only owned personally by users but also located in Internet cafes, convenience stores and gas stations and publicly shared.

The content delivery server 10 comprises a storage unit 11 such as a HDD (Hard Disc Drive), and a control unit 12 such as a CPU (Central Processing Unit). A function of the control unit 12 can be realized with a program read out of the storage unit 11.

The storage unit 11 includes a content data DB111, a content meta-data DB 112, and a ST-targeted user key data DB 113. Additionally, the storage unit 11 stores the above-described program and so forth. The description “DB” indicates a database.

The content data DB 111 is used to store n-pieces of plaintext content data Ci (i=1−n). The content key data DB 112 is used to store n-pieces (n=1, 2, . . . , n) of content key data Kci (i=1−n) for use in encryption of n-pieces of plaintext content data Ci, respectively. The ST-targeted user key data DB 113 is used to store m-pieces (m<<n) of streaming-targeted (ST-targeted) user key data Kusi (i=1−m) for use in encryption of each content key data Kc. A different set of ST-targeted user key data Kusi is properly used for every content data Ci and the same set of Kusi can be used commonly by even different user terminals. In a word, even if any user terminal is used in decryption of certain encrypted content key data Enc(Kusi:Kci), the decryption can be achieved with ST-targeted user key data Kusi corresponding to that data.

The control unit 12 includes a packet generator 121, a first encryptor 122, a second encryptor 123, an ID assignor 124, a TS multiplexer 125, and a transmitter 126.

The packet generator 121 has a function of packetizing content data C into a PES (Packetized Elementary Stream). The first encryptor 122 has a function of encrypting the PES-packetized content data Ci with content key data Kci corresponding to that content data Ci to generate encrypted content data Enc(Kci:Ci). The second encryptor 123 has a function of encrypting the content key data Kci with the ST-targeted user key data Kusi to generate encrypted content key data Enc(Kusi:Kci). The ID assignor 124 assigns first identification data ENCKID to the ST-targeted user key data Kusi and the encrypted content key data Enc(Kusi:Kci). The first identification data ENCKID is such data that is used in identification of one of m ST-targeted user keys Kusi.

The TS multiplexer 125 has a function of TS (Transport Stream)-multiplexing the encrypted content data Enc(Kci:Ci) and the encrypted content key data Enc(Kusi:Kci) to generate a transport stream. The transmitter 126 has a function of transmitting the transport stream generated at the TS multiplexer 125 to the user terminals 20A-20C over the communications network 30.

The user terminals 20A-20C have the same configuration except part of stored data. The configuration of the user terminal 20A is herein described as an example.

The user terminal 20A includes a display controller 21, an input/output (I/O) unit 22, a RAM 23, a control unit 24 such as a CPU, a first storage unit 25A such as a SD card, and a second storage unit 26 such as a HDD.

The control unit 24 includes a transmitter/receiver 241, and a retention controller 242. The configuration of the control unit 24 can be realized by executing the program stored in the first storage unit 25A.

The transmitter/receiver 241 has a function of data transmitting to and receiving from external. The retention controller 242, with the use of the first storage unit 25A, has a function of temporarily storing the encrypted content data Enc(Kci:Ci) and the encrypted content key data Enc(Kusi:Kci) contained in the transport stream obtained through streaming reception. The retention controller 242, if the decrypted content data Ci is reproduced, has a function of erasing that content data Ci.

In the first storage unit 25A, a system area 251 stores key management information MKB (Media Key Block) and a media identifier IDm, a hidden area 252 stores a media unique key Kmu1, and a protected area 253 stores encrypted user key data Enc(Kmu1:Kusi). As already mentioned, this key data Kusi is used commonly in each user terminal 20A-20C. Further, a user data area 254 stores encrypted content key data Enc(Kusi:Kci) and encrypted content data Enc(Kci:Ci), received at the content delivery server 10. The encrypted content key data Enc(Kusi:Kci) and the encrypted content data Enc(Kci:Ci) may be stored temporarily in the RAM 23 instead of the user data area 254. The encrypted content data Enc(Kci:Ci) may be stored in the second storage unit 26.

The media unique key Kmu varies among the user terminals 20A-20C. For example, the media unique key Kmu1 is stored in the first storage unit 25A of the user terminal 20A, and the media unique key Kmu2 is stored in the storage unit 25B of the user terminal 20B.

The encrypted user key data Enc(Kmu1:Kusi) is obtained by receiving the ST-targeted user key data Kusi at the content delivery server 10 at a certain time, and encrypting it with the media unique key Kmu1 at the encryptor/decryptor 255. The certain time may be a time at which the user of the user terminal 20A and the administrator of the content delivery server 10 make a content audience contract for that user.

The system area 251 is a read-only area, which is accessible from outside the first storage unit 25A. The hidden area 252 is a read-only area, which is referenced by the first storage unit 25A itself and absolutely inaccessible from outside. The protected area 253 is an area, which is readable/writable from outside the first storage unit 25A with a success of authentication. The user data area 254 is an area, which is freely readable/writable from outside the first storage unit 25A. The encryptor/decryptor 255 executes authentication, key exchange and cipher communications between the protected area 253 and the first storage unit 25A, and has an encryption/decryption function.

The second storage unit 26 is used to store the encrypted content data Enc(Kci:Ci) received and other data such as programs.

### Operation of First Embodiment

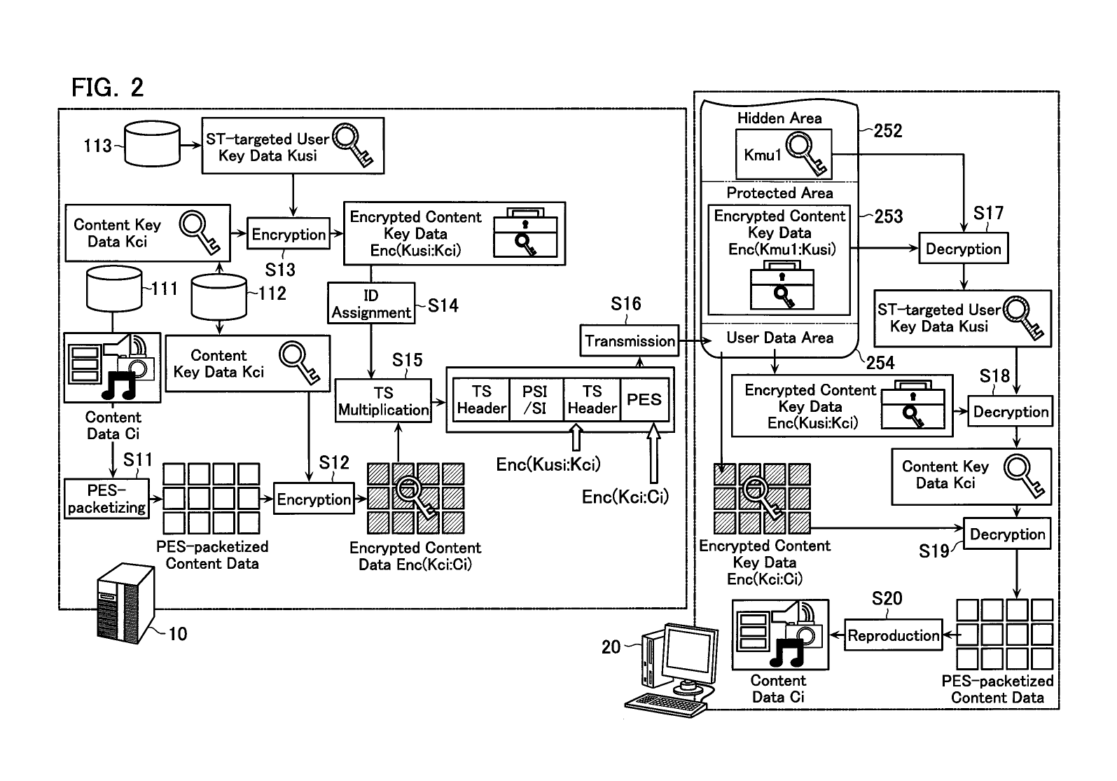

Referring to FIG. 2, operation of the content delivery system of the first embodiment is described next. FIG. 2 is a conceptual view showing operation of the content delivery system of the first embodiment. FIG. 2 shows operation performed between the content delivery server 10 and the user terminal 20A when streaming data is viewed at the user terminal. Similar operation is also performed between the content delivery server 10 and the user terminal 20B, 20C.

As shown in FIG. 2, first, in the content delivery server 10, the packet generator 121 reads content data Ci from the content data DB 111 for PES-packetizing (step S11). Through this step S11, PES-packetized content data C is generated. Subsequently, the first encryptor 122 encrypts the PES-packetized content data Ci with the content key data Kci (step S12). Through this step S12, encrypted content data Enc(Kci:Ci) is generated.

On the other hand, the second encryptor 123 encrypts the content key data Kci with the ST-targeted user key data Kusi (step S13). Through this step S13, encrypted content key data Enc(Kusi:Kci) is generated. After the encryption at step S13, the ID assignor 124 assigns first identification data ENCKID to the generated encrypted content key data Enc(Kusi:Kci) (step S14).

Subsequently, the TS multiplexer 125 TS-multiplexes the encrypted content data Enc(Kci:Ci) and the encrypted content key data Enc(Kusi:Kci) to generate a transport stream (step S15). The transport stream herein mainly includes TS header, PSI/SI (Program Specific Information/Service Information), TS header, and PES (Packetized Elementary Stream). The TS multiplexer 125 performs TS-multiplexing such that the encrypted content data Enc(Kci:Ci) can be contained in the PES and the encrypted content key data Enc(Kusi:Kci) can be contained in the TS header.

The transmitter 126 transmits the transport stream generated as above to the user terminal 20A over the communications network 30 (step S16). The transport stream received at the user terminal 20A is stored in the user data area 254 of the first storage unit 25A.

Then, in the user terminal 20A, the encryptor/decryptor 255 specifies ST-targeted user key data Kusi capable of decrypting the encrypted content key information Enc(Kusi:Kci) with the first identification data ENCKID.

Subsequently, the encryptor/decryptor 255 reads the unique key Kmu1 from the hidden area 251 in the first storage unit 25A, also reads the previously stored, encrypted user key data Enc(Kmu1:Kusi) from the protected area 252, and then decrypts the encrypted user key data Enc(Kmu1:Kusi) with the unique key Kmu1 (step S17). Through the processing at this step S17, ST-targeted user key data Kusi is generated.

Subsequently, the encryptor/decryptor 255 reads the encrypted content key information Enc(Kusi:Kci) from the user data area 254, and then decrypts the encrypted content key information Enc(Kusi:Kci) with the generated, ST-targeted user key data Kusi (step S18). Through the processing at this step S18, content key data Kci is generated. Subsequently, the encryptor/decryptor 255 reads the encrypted content data Enc(Kci:Ci) from the user data area 254, and then decrypts it with the generated content key data Kci (step S19). Through the processing at this step S19, PES-packetized plain text content data Ci is generated. Then, the display controller 21 reproduces the plaintext content data Ci (step S20). Through the above operations, the user of the user terminal 20A can view the content data Ci.

In accordance with the configuration and operation according to the first embodiment, the ST-targeted user key data Kusi (i=1-m) common to the user terminals 20A-20C can be used to encrypt content key data Kci (i=1-n) to generate encrypted content key data Enc(Kusi:Kci). In accordance with the configuration and operation according to the first embodiment, it is further possible to generate a transport stream based on the encrypted content data Enc(Kci:Ci) with the encrypted content key data Enc(Kusi:Kci) added to the TS header, and transmit it to the user terminals 20A-20C. Therefore, the amount of information to be transmitted to the user terminals 20A-20C can be reduced. This makes it possible to suppress the press of traffics and achieve the delivery of content data C1 and the reproduction at the user terminals 20A-20C.

### Second Embodiment

### Configuration of Second Embodiment

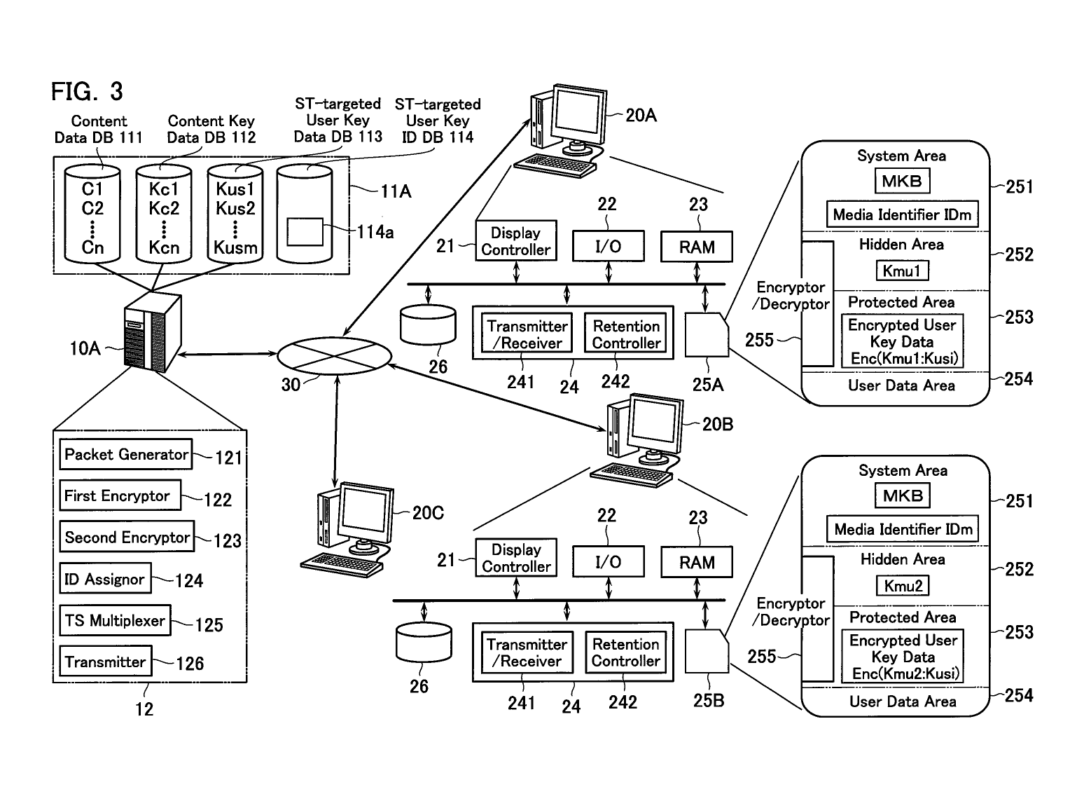

Referring to FIG. 3, a content delivery system according to a second embodiment is described next. FIG. 3 is a general diagram of the content delivery system according to the second embodiment. As shown in FIG. 3, the content delivery system according to the second embodiment differs in configuration of a storage unit 11A in the content delivery system 10A from the first embodiment. In the second embodiment, the similar parts as those in the first embodiment are denoted with the same reference numerals and omitted from the following description.

The storage unit 11A includes a streaming-targeted (ST-targeted) user ID DB 114 in addition to the configuration of the first embodiment. The ST-targeted user ID DB 114 is used to store key management table data 114a.

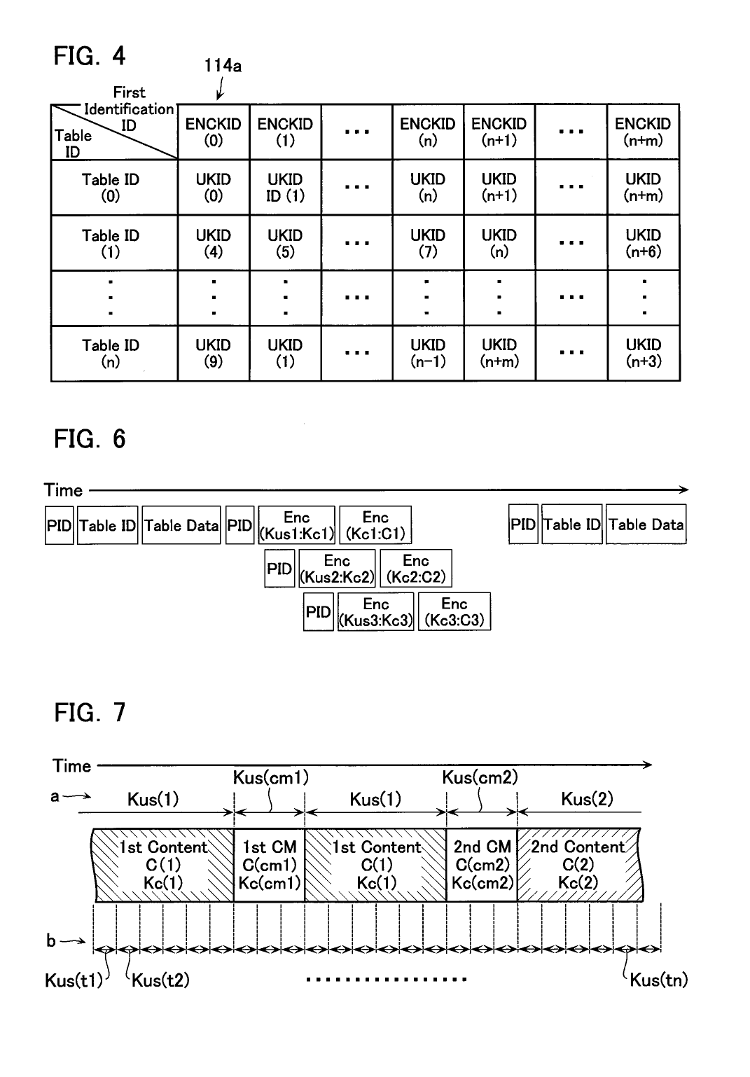

As shown in FIG. 4, the key management table data 114a shows relations among first identification data ENCKID that identifies one of m ST-targeted user keys Kusi, second identification data UKID that specifies the first identification data ENCKID, and Table ID. The Table ID corresponds, for example, to the type of a contract made between the administrator of the content delivery server 10 and the user of the user terminal 20A (such as a contract for visible/audible content data).

For example, in the key management table 114a shown in FIG. 4, it is assumed that the user has made a contract of Table ID(1) and second identification data UKID(5) is assigned to the encrypted content key data Enc(Kusi:Kci). In this case, on the basis of the key management table data 114a, one of plural pieces of user key data Kusi is identified based on the first identification data ENCKID(1).

The first identification data ENCKID may be configured to relate to the second identification data UKID in all different manners at Table ID ((1)-(n)) as shown in FIG. 4. Alternatively, certain first identification data (ENCKID(0)-(n)) may be configured to relate to corresponding second identification data UKID not in different manners at Table ID ((1)-(n)) but in the same manner. The key management table data 114a may be configured such that it is updated every certain elapsed time by changing the relation between the first identification data ENCKID and the second identification data UKID.

### Operation of Second Embodiment

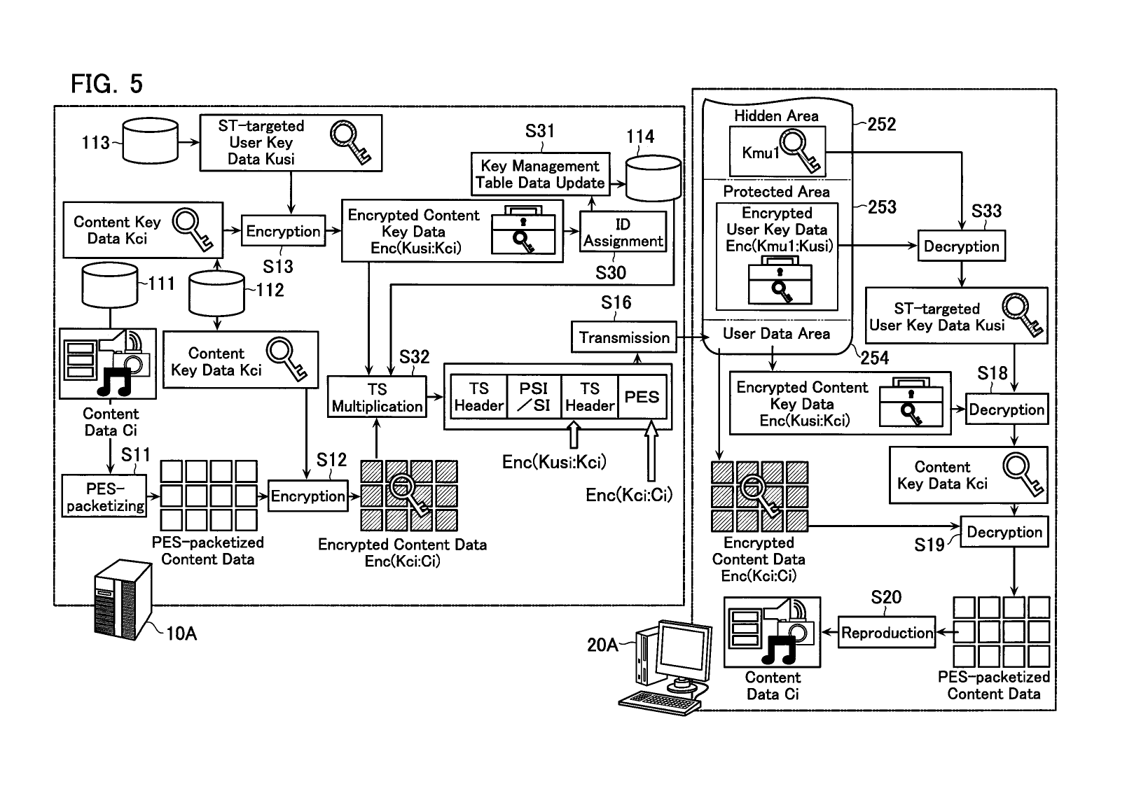

Referring to FIG. 5, operation of the content delivery system of the second embodiment is described next. FIG. 5 is a conceptual view showing operation of the content delivery system according to the second embodiment. FIG. 5 shows operation performed between a content delivery server 10A and the user terminal 20A. Similar operation is also performed between the content delivery server 10A and the user terminal 20B, 20C. As shown in FIG. 5, in the operation according to the second embodiment, step S14, step S15 and step S17 in the first embodiment are replaced with step S30, step S32 and step S33, and operation in step S31 is newly executed before step S32 (after step S30).

In the content delivery server 10A of the second embodiment, after the processing at step S13, the ID assignor 124 assigns second identification data UKID to the generated encrypted content key data Enc(Kusi:Kci) (step S30).

Then, based on the second identification data UKID assigned at step S30, the ID assignor 124 generates or updates the above-described key management table data 114a (step S31). Subsequently, the TS multiplexer 125 TS-multiplexes the encrypted content data Enc(Kci:Ci), the encrypted content key data Enc(Kusi:Kci) and the key management table data 114a to generate a transport stream (step S32). Then, the similar operation at step S16 is performed as in the first embodiment.

Subsequently, in the user terminal 20A, the encryptor/decryptor 255 specifies ST-targeted user key data Kusi capable of decrypting the encrypted content key information Enc(Kusi:Kci) indirectly based on the second identification data UKID and the key management table data 114a. Subsequently, the encryptor/decryptor 255 reads the unique key Kmu1 from the hidden area 251 in the first storage unit 25A, also reads the previously stored, encrypted user key data Enc(Kmu1:Kusi) from the protected area 252, and then decrypts the encrypted user key data Enc(Kmu1:Kusi) with the unique key Kmu1 (step S33). Then, the similar operation at steps S18-S20 is performed as in the first embodiment.

Referring next to FIG. 6, a method of transmitting the key management table data 114a is described. FIG. 6 shows a configuration of 1ch Multi Stream for use in the second embodiment. As shown in FIG. 6, a TS header containing a Payload unit start Indicator (PID) is transmitted. The content of each data can be identified by the PID. Following the PID, Table ID and Table Data are transmitted (the key management table data 114a is transmitted). Then, plural transport streams containing PID, encrypted content key data Enc(Kusi:Kci) and encrypted content data Enc(Kci:Ci) are multiplexed and transmitted. The key management table data 114a has information only about the transmitted encrypted content data Enc(Kc1:C1)-Enc(Kc3:C3) and encrypted content key data Enc(Kus1:Kc1)-Enc(Kus3:Kc3). After reproduction of content data C1-C3, the referenced key management table data 114a is erased together with the content data C1-C3.

Referring next to FIG. 7, a data area of content key data Kci to be encrypted is described. FIG. 7 shows a data area of content key data Kci to be encrypted with user key data Kusi in the content delivery system according to the second embodiment of the present invention. FIG. 7 shows a transmission of 1st content data C(1), followed by 1st CM data C(cm1) sandwiched, and then subsequent 1st content data C(1), and a further transmission of 2nd CM data 2 (cm2) sandwiched and then 2nd content data C(2), with time elapsed. In FIG. 7 it is assumed that the 1st content data C(1) is encrypted with content key data Kc(1) and the 2nd content data C(2) with content key data Kc(2). It is also assumed that the 1st CM data C(cm1) is encrypted with content key data Kc(cm1) and the 2nd CM data 2 (cm2) is encrypted with content key data Kc(cm2).

The second encryptor 123 may be configured to encrypt each content key data (Kc(1),Kc(2),Kc(cm1),Kc(cm2)) with respective one ST-targeted user key data (Kus(1), Kus(2), Kus(cm1), Kus(cm2)) within a range as shown a symbol “a” in FIG. 7 with both ends of an arrow.

The second encryptor 123 may also be configured to encrypt each content key data (Kc(1), Kc(2), Kc(cm1), Kc(cm2)) with different ST-targeted user key data (Kus(t1), Kus(t2), . . . , Kus(tn)) at every certain time as shown a symbol “b” in FIG. 7 with both ends of an arrow.

The second embodiment with the above configuration exerts the same effect as the first embodiment. The configuration of the second embodiment makes it possible to assign second identification data UKID to encrypted content key data Enc(Kusi:Kci) and identify the user key data Kusi based on the key management table data 114a that shows the relation between that second identification data UKID and the first identification data ENCKID. Therefore, it is possible to achieve an enhanced level of security and a reduced amount of information transmitted to the user terminals 20A-20C over the communications network 20 compared to the direct designation of ST-targeted user key data Kusi from first identification data ENCKID assigned to encrypted content key data Enc(Kusi:Kci) (the first embodiment).

One embodiment of the invention is described above though the present invention is not limited to these but rather can be given various variations, additions and replacements without departing from the scope and spirit of the invention. The above one embodiment is configured to use the encrypted double key scheme applied in MQbic but may use other schemes. For example, it may be configured to previously transmit service key data Sk to the user terminal 20A and transmit encrypted content key data Enc(Kusi:Kci) further encrypted with the service key data Sk to the user terminal 20A (the configuration of a triple double key scheme).

The encrypted content key data Enc(Kusi:Kci) is not limited to the configuration that is erased at the time of reproduction of content data Ci. For example, the encrypted content key data Enc(Kusi:Kci) may be set such that it can not be decrypted or may be erased when a certain time elapsed after the reception by the user terminal (expiration date setting). The content delivery server 10 may be configured to transmit the encrypted content key data Enc(Kusi:Kci) again to the user terminals 20A-20C in response to a request from the user terminals 20A-20C after the expiration date of the encrypted content key data Enc(Kusi:Kci). For example, in this case, third identification data for use in identification of the encrypted content key data Enc(Kusi:Kci) may be assigned to encrypted content data Enc(Kci:Ci) previously, and the third identification data may be used to request the encrypted content key data Enc(Kusi:Kci).

What is claimed is:

1. A content delivery server, comprising:
a packet generator operative to generate packetized content data;
an encryptor operative to encrypt said packetized content data with content key data to generate encrypted content data and also operative to encrypt said content key data with user key data to generate encrypted content key data;
a TS multiplexer operative to multiplex said encrypted content data into a transport stream and add said encrypted content key data to a TS header thereof; and
a transmitter operative to transmit said transport stream to a user terminal.

2. The content delivery server according to claim 1, wherein said user key data is commonly used in a plurality of user terminals.

3. The content delivery server according to claim 1, wherein said user key data comprises plural pieces of user key data, which are commonly used in a plurality of user terminals.

4. The content delivery server according to claim 3, wherein said encryptor encrypts said content key data with one user key data of said plural pieces of user key data.

5. The content delivery server according to claim 3, wherein said encryptor encrypts said content key data with said plural pieces of user key data, which vary on an elapsed-time basis.

6. The content delivery server according to claim 3, further comprising an ID assignor operative to assign first identification data for identification of one user key data of said plural pieces of user key data to said encrypted content key data,
wherein said transmitter transmits said encrypted content data and said encrypted content key data assigned with said first identification data to said user terminal.

7. The content delivery server according to claim 3, further comprising:
key management table data including plural pieces of first identification data for identification of one user key data of said plural pieces of user key data, and second identification data for identification of one first identification data of said plural pieces of first identification data; and
an ID assignor operative to assign said second identification data to said encrypted content key data,
wherein said transmitter transmits said encrypted content data and said encrypted content key data assigned with said second identification data to said user terminal.

8. The content delivery server according to claim 7, wherein said key management table data is added to a TS packet in said transport stream.

9. The content delivery server according to claim 1, wherein said content data is encrypted in a double key scheme or a triple key scheme.

10. A content delivery system, comprising:
a user terminal held by a user; and
a content delivery server operative, in response to a request for content data from said user terminal, to encrypt said content data with content key data and deliver said encrypted content data,
wherein said content delivery server includes
a packet generator operative to generate packetized content data,
an encryptor operative to encrypt said packetized content data with content key data to generate encrypted content data and also operative to encrypt said content key data with user key data to generate encrypted content key data,
a TS multiplexer operative to multiplex said encrypted content data into a transport stream and add said encrypted content key data to a TS header thereof, and
a transmitter operative to transmit said transport stream to a user terminal,
wherein said user terminal includes
a receiver operative to receive said transport stream,
a decryptor operative to decrypt said encrypted content data contained in said received transport stream, based on said encrypted content key data added to a TS header of said transport stream, and
a reproducer operative to reproduce said decrypted encrypted content data.

11. The content delivery system according to claim 10, wherein said user key data is commonly used in a plurality of user terminals.

12. The content delivery system according to claim 10, wherein said user key data comprises plural pieces of user key data, which are commonly used in a plurality of user terminals.

13. The content delivery system according to claim 12, wherein said encryptor encrypts said content key data with one user key data of said plural pieces of user key data.

14. The content delivery system according to claim 12, wherein said encryptor encrypts said content key data with said plural pieces of user key data, which vary on an elapsed-time basis.

15. The content delivery system according to claim 12, further comprising an ID assignor operative to assign first identification data for identification of one user key data of said plural pieces of user key data to said encrypted content key data,
wherein said transmitter transmits said encrypted content data and said encrypted content key data assigned with said first identification data to said user terminal.

16. The content delivery system according to claim 12, further comprising:
key management table data including plural pieces of first identification data for identification of one user key data of said plural pieces of user key data, and second identification data for identification of one first identification data of said plural pieces of first identification data; and
an ID assignor operative to assign said second identification data to said encrypted content key data,
wherein said transmitter transmits said encrypted content data and said encrypted content key data assigned with said second identification data to said user terminal.

17. The content delivery system according to claim 16, wherein said key management table data is added to a TS packet in said transport stream.

18. The content delivery system according to claim 10, wherein said content data is encrypted in a double key scheme or a triple key scheme.
